(19) United States
(12) Patent Application Publication
(10) Pub. No.: US 2014/0195356 A1
(43) Pub. Date: Jul. 10, 2014

(54) Advertisement display method of mobile communication terminal using button bar or notification bar, and apparatus thereof

(71) Applicant: J & Comms Co., Ltd., Seoul (KR)

(72) Inventor: Hyun-Jae Kim, Seoul (KR)

(73) Assignee: J & Comms Co., Ltd., Seoul (KR)

(21) Appl. No.: 14/241,742

(22) PCT Filed: Aug. 2, 2013
(86) PCT No.: PCT/KR2013/006987

§ 371 Date: Feb. 27, 2014

(30) Foreign Application Priority Data
Aug. 17, 2012 (KR) 10-2012-0090036

(51) Int. Cl. G06Q 30/02

(52) U.S. Cl. CPC G06Q 30/0267
USPC 705/14.64

(57) ABSTRACT

The present invention relates to a method for displaying an advertisement in a mobile communication terminal using a button bar (icon) or an indication bar (icon), and an apparatus thereof, the method comprising the steps of: sensing whether a user operates a call allowance button bar; and inserting and displaying advertisement contents on a predetermined first set screen (or area) within the call allowance button bar when sensing the user operation for the call allowance button bar according to the sensed result. In addition, the present invention can effectively provide the advertisement for the user by using the call allowance/rejection button bar (icon) or the indication bar (icon) such as a character and the like.

### CROSS-REFERENCE TO RELATED APPLICATION

This Application is a Section 371 National Stage Application of International Application No. PCT/KR2013/006987, filed Aug. 2, 2013, the contents of which is hereby incorporated by reference in its entirety.

### BACKGROUND OF THE INVENTION

1. Technical Field

The present invention relates to an advertisement display method of a mobile communication terminal using a button bar (icon) or an indication bar (icon) of a character message or the like and an apparatus thereof. More particularly, the present invention relates to an advertisement display method of a mobile communication terminal using a button bar (icon) or an indication bar (icon) of a character message or the like and an apparatus thereof, which provide an advertisement by displaying an advertisement bar (icon) containing advertisement contents or the indication bar (icon) of a character message or the like on a screen when a call or an indication signal is input, admits a call or an indication when a user handles the advertisement bar (icon) or the indication bar (icon) of a character message or the like in a first set direction (e.g., from the left to the right, or a touch or the like), and rejects the call or the indication when the user handles the advertisement bar (icon) or the indication bar (icon) of a character message or the like in a second set direction (e.g., from the right to the left, or a touch or the like).

2. Background Art

A smart phone which is widely known through media or the like and generalized recently means an intelligent cellular phone adding computer supporting functions to a cellular phone (Source: Daum dictionary of IT terminologies).

Generally, some of personal digital assistant (PDA) functions, Internet functions, remote controller functions and the like are added to the smart phone, and the smart phone is equipped with a variety of interfaces convenient to use such as an input device of a handwriting type, a touch screen and the like.

Furthermore, the smart phone is connected to the Internet or a computer with the support of wireless Internet functions and performs a function as a terminal executing an e-mail, web browsing, facsimile, on-line banking, a game or the like. In addition, the smart phone is equipped with a standardized or dedicated operating system (OS) in order to accommodate a variety of functions.

Such a smart phone has a problem of satisfying both miniaturization for providing convenience of portability and enlargement for improving resolution and identification of an output image. Furthermore, since the smart phone should be combined with an input means for handling the smart phone, enlargement of the smart phone is an unavoidable difficult problem in order to complete a smart phone having multiple functions. To solve such a difficult problem, a touch screen technique is applied to integrate input and output means of the smart phone.

As described above, a touch screen is a device provided with both an output function and an input function, and the input means does not need to be separately combined since the touch screen is applied to the smart phone, and both the effects of miniaturization and enlargement of the smart phone may be realized by applying the touch screen.

Meanwhile, the current advertisement market requires an advertisement medium which can effectively guide and advertise various kinds of goods and services to consumers of various preferences, and a new communication environment creates new advertisement media to meet such a requirement.

In such a circumstance, it is required to provide an advertisement display apparatus installed in a smart phone and an advertisement display method using thereof so that an effective advertisement can be performed using the smart phone which becomes a necessity for modern people.

For reference, related prior techniques disclosing an appropriate background art in relation to the present invention are as follows.

Korean Laid-opened Patent No. 10-2010-0043953 (Title of the invention: Mobile advertisement system and advertisement method using the same), Korean Laid-opened Patent No. 10-2003-0079422 (Title of the invention: Method of discounting fare if advertisement displayed on LCD of cellular phone together with caller ID is viewed when call is made), and Korean Laid-opened Patent No. 10-2008-0015563 (Title of the invention: Advertisement agency business system for providing advertisement using screen displayed on terminal as medium when call of cellular phone is received).

### DISCLOSURE

### Technical Problem

The present invention has been developed to solve the above problems, and an object of the present invention is to provide an advertisement display method of a mobile communication terminal using a button bar (icon) or an indication bar (icon) of a character message or the like and an apparatus thereof, which can effectively provide an advertisement to a user using the call allowance/rejection button bar (icon) or the indication bar (icon) of a character message or the like provided in a smart phone and, in addition, allows the user to view the advertisement through the call allowance/rejection button bar (icon) or the indication bar (icon) of a character message or the like and to be provided with an advantageous effect since points (or cash) are accumulated as much as the number of times of viewing the advertisement, from the viewpoint of the user.

### Technical Solution

To achieve the above object, according to one aspect of the present invention, an advertisement display method of a mobile communication terminal using a button bar (an icon) or an indication bar (an icon) of a character message or the like includes the steps of: providing an advertisement by displaying an advertisement bar (an icon) containing advertisement contents on a screen when a call signal is input; and admitting a call when a user handles the advertisement bar (an icon) in a first set direction (e.g., from the left to the right or a touch) and rejecting the call when the user handles the advertisement bar in a second set direction (e.g., from the right to the left or a touch).

Preferably, insertion of the advertisement contents is storing a plurality of advertisement contents in advance, selecting any one of the advertisement contents using a set sequence or a random method among the plurality of the stored advertisement contents, and inserting the advertisement contents in the advertisement bar, and the advertisement contents are received from a predetermined advertisement server and periodically updated.

In addition, the advertisement display method further includes a point management step for accumulating and adding points (or cash) whenever the advertisement contents are displayed or the number of times of displaying the advertisement contents exceeds a set number and transmitting a result thereof to a point management server to inform the points when the user requests or each time a set time period is elapsed, when the advertisement contents are displayed through the advertisement bar (an icon).

Preferably, the advertisement display method further includes the step of providing an advertisement by displaying an advertisement object (e.g., an image, text, flash or the like) containing advertisement contents, together with a corresponding indication icon, when arrival of predetermined indication information (e.g., a character message, Kakao talk, Facebook, or the like) is notified, in which when the advertisement object is touched, the mobile communication terminal is automatically connected to a predetermined site or a home page of a corresponding company.

In addition, indication of a character message or the like is admitted when the user handles the advertisement object in a first set direction (e.g., from the left to the right or a touch), and the indication of a character message or the like is rejected when the user handles the advertisement object in a second set direction (e.g., from the right to the left or a touch).

Additionally, the advertisement display method further includes the step of sensing whether or not the call is terminated and inserting and, if termination of the call is sensed as a result of the sensing, displaying advertisement contents on a predetermined set screen (area), in which when the advertisement contents are touched, the mobile communication terminal is automatically connected to a predetermined site or a home page of a corresponding company.

To achieve the above object, according to another aspect of the present invention, in an advertisement display method of a mobile communication terminal provided with a call allowance button bar and a call rejection button bar, the advertisement display method of a mobile communication terminal using a button bar or an indication bar includes the steps of: sensing whether or not a user handles the call allowance button bar; and inserting and displaying advertisement contents on a predetermined first set screen (area) inside the call allowance button bar if it is sensed that the user handles the call allowance button bar as a result of the sensing.

Preferably, the advertisement display method further includes the steps of sensing whether or not the user handles the call rejection button bar; and inserting and displaying advertisement contents on a predetermined second set screen (area) inside the call rejection button bar if it is sensed that the user handles the call rejection button bar as a result of the sensing.

In addition, the advertisement display method further includes the steps of sensing whether or not the call is terminated and, if termination of the call is sensed as a result of the sensing, inserting and displaying advertisement contents on a predetermined third set screen (area), by the mobile communication terminal.

Preferably, insertion of the advertisement contents is storing a plurality of advertisement contents in advance, selecting any one of the advertisement contents using a set sequence or a random method among the plurality of the stored advertisement contents, and inserting the advertisement contents in the call allowance button bar or the call rejection button bar, and the advertisement contents are received from a predetermined advertisement server and periodically updated.

In addition, the advertisement display method further includes a point management step for accumulating and adding points (or cash) whenever the advertisement contents are displayed or the number of times of displaying the advertisement contents exceeds a set number and transmitting a result thereof to a point management server to inform the points when the user requests or each time a set time period is elapsed, when the advertisement contents are displayed through the call allowance button bar or the call rejection button bar.

Preferably, the advertisement display method further includes the step of providing an advertisement by displaying an advertisement object (e.g., an image, text, flash or the like) containing advertisement contents, together with a corresponding indication icon, when arrival of predetermined indication information (e.g., a character message, Kakao talk, Facebook, or the like) is notified, in which when the advertisement object is touched, the mobile communication terminal is automatically connected to a predetermined site or a home page of a corresponding company.

In addition, indication of a character message or the like is admitted when the user handles the advertisement object in a first set direction (e.g., from the left to the right or a touch), and the indication of a character message or the like is rejected when the user handles the advertisement object in a second set direction (e.g., from the right to the left or a touch).

To achieve the above object, according to still another aspect of the present invention, in an advertisement display method of a mobile communication terminal provided with a call/rejection combination button bar for admitting a call when a user handles the button bar in a first set direction and rejecting the call when the user handles the button bar in a second set direction, the advertisement display method of a mobile communication terminal using a button bar or an indication bar includes the steps of sensing whether or not the user handles the call/rejection combination button bar; and inserting and displaying advertisement contents on a predetermined first set screen (area) inside the call/rejection combination button bar if it is sensed that the user handles the call/rejection combination button bar in the first set direction as a result of the sensing.

Preferably, the advertisement display method further includes the step of inserting and displaying advertisement contents on a predetermined second set screen (area) inside the call/rejection combination button bar if it is sensed that the user handles the call/rejection combination button bar in the second set direction as a result of the sensing.

In addition, the advertisement display method further includes the steps of sensing whether or not the call is terminated and, if termination of the call is sensed as a result of the sensing, inserting and displaying advertisement contents on a predetermined third set screen (area), by the mobile communication terminal, in which when the advertisement contents are touched, the mobile communication terminal is automatically connected to a predetermined site or a home page of a corresponding company.

Preferably, insertion of the advertisement contents is storing a plurality of advertisement contents in advance, selecting any one of the advertisement contents using a set sequence or a random method among the plurality of the stored advertisement contents, and inserting the advertisement contents in the call/rejection combination button bar.

In addition, the advertisement contents are received from a predetermined advertisement server and periodically updated.

Preferably, the advertisement display method further includes a point management step for accumulating and adding points (or cash) whenever the advertisement contents are displayed or the number of times of displaying the advertisement contents exceeds a set number and transmitting a result thereof to a point management server to inform the points when the user requests or each time a set time period is elapsed, when the advertisement contents are displayed through the call/rejection combination button bar.

In addition, the advertisement display method further includes the step of providing an advertisement by displaying an advertisement object (e.g., an image, text, flash or the like) containing advertisement contents, together with a corresponding indication icon, when arrival of predetermined indication information (e.g., a character message, Kakao talk, Facebook, or the like) is notified, in which when the advertisement object is touched, the mobile communication terminal is automatically connected to a predetermined site or a home page of a corresponding company.

Preferably, indication of a character message or the like is admitted when the user handles the advertisement object in a first set direction (e.g., from the left to the right or a touch), and the indication of a character message or the like is rejected when the user handles the advertisement object in a second set direction (e.g., from the right to the left or a touch).

To achieve the above object, according to still another aspect of the present invention, an advertisement display apparatus of a mobile communication terminal using a button bar or an indication bar includes: an advertisement bar insertion module for providing an advertisement by displaying an advertisement bar containing advertisement contents on a screen when a call signal is input; and a call processing module for admitting a call when a user handles the advertisement bar in a first set direction (from the left to the right) and rejecting the call when the user handles the advertisement bar in a second set direction (from the right to the left).

Preferably, insertion of the advertisement contents is storing a plurality of advertisement contents in advance, selecting any one of the advertisement contents using a set sequence or a random method among the plurality of the stored advertisement contents, and inserting the advertisement contents in the advertisement bar, and the advertisement contents may be received from a predetermined advertisement server and periodically updated.

In addition, the advertisement display apparatus further includes a point management unit for accumulating and adding points (cash) whenever the advertisement contents are displayed or the number of times of displaying the advertisement contents exceeds a set number and transmitting a result thereof to a point management server to inform the points when the user requests or each time a set time period is elapsed, when the advertisement contents are displayed through the advertisement bar.

Preferably, the advertisement display apparatus further includes an advertisement object indication unit for providing an advertisement by displaying an advertisement object (e.g., an image, text, flash or the like) containing advertisement contents, together with a corresponding indication icon, when arrival of predetermined indication information (e.g., a character message, Kakao talk, Facebook, or the like) is notified.

In addition, indication of a character message or the like is admitted when the user handles the advertisement object in a first set direction (e.g., from the left to the right or a touch), and the indication of a character message or the like is rejected when the user handles the advertisement object in a second set direction (e.g., from the right to the left or a touch).

To achieve the above object, according to another aspect of the present invention, in an advertisement display apparatus of a mobile communication terminal provided with a call allowance button bar and a call rejection button bar, the advertisement display apparatus of a mobile communication terminal using a button bar or an indication bar includes: a first sensing module for sensing whether a user handles the call allowance button bar or the call rejection button bar; and a first advertisement insertion module for inserting and displaying advertisement contents on a first set screen (or area) inside the call allowance button bar if it is sensed that the user handles the call allowance button bar as a result of the sensing, and inserting and displaying advertisement contents on a second set screen (or area) inside the call rejection button bar if it is sensed that the user handles the call rejection button bar as a result of the sensing.

Preferably, the advertisement display apparatus further includes a second advertisement insertion module for sensing whether or not the call is terminated and, if termination of the call is sensed as a result of the sensing, inserting and displaying advertisement contents on a third set screen (area).

In addition, insertion of the advertisement contents is storing a plurality of advertisement contents in advance, selecting any one of the advertisement contents using a set sequence or a random method among the plurality of the stored advertisement contents, and inserting the advertisement contents in the call allowance button bar or the call rejection button bar.

Preferably, the advertisement contents are received from a predetermined advertisement server and periodically updated.

In addition, the advertisement display apparatus further includes a first point management unit for accumulating and adding points (or cash) whenever the advertisement contents are displayed or the number of times of displaying the advertisement contents exceeds a set number and transmitting a result thereof to a point management server to inform the points when the user requests or each time a set time period is elapsed, when the advertisement contents are displayed through the call allowance button bar or the call rejection button bar.

Preferably, the advertisement display apparatus further includes an advertisement object indication unit for providing an advertisement by displaying an advertisement object (e.g., an image, text, flash or the like) containing advertisement contents, together with a corresponding indication icon, when arrival of predetermined indication information (e.g., a character message, Kakao talk, Facebook, or the like) is notified.

In addition, indication of a character message or the like is admitted when the user handles the advertisement object in a first set direction (e.g., from the left to the right or a touch), and the indication of a character message or the like is rejected when the user handles the advertisement object in a second set direction (e.g., from the right to the left or a touch).

To achieve the above object, according to still another aspect of the present invention, in an advertisement display apparatus of a mobile communication terminal provided with a call/rejection combination button bar which admits a call when a user handles the call/rejection combination button bar in a first set direction and rejects the call when the user handles the call/rejection combination button bar in a second set direction, the advertisement display apparatus of a mobile communication terminal using a button bar or an indication bar includes: a second sensing module for sensing whether or not the user handles the call/rejection combination button bar; and a third advertisement insertion module for inserting and displaying advertisement contents on a predetermined first set screen (or area) inside the call/rejection combination button bar if it is sensed that the user handles the call/rejection combination button bar in the first set direction as a result of the sensing, and inserting and displaying advertisement contents on a predetermined second set screen (or area) inside the call/rejection combination button bar if it is sensed that the user handles the call/rejection combination button bar in the second set direction as a result of the sensing.

Preferably, the advertisement display apparatus further includes a fourth advertisement insertion module for sensing whether or not the call is terminated and, if termination of the call is sensed as a result of the sensing, inserting and displaying advertisement contents on a predetermined third set screen (or area).

In addition, insertion of the advertisement contents is storing a plurality of advertisement contents in advance, selecting any one of the advertisement contents using a set sequence or a random method among the plurality of the stored advertisement contents, and inserting the advertisement contents in the call/rejection combination button bar.

Preferably, the advertisement contents are received from a predetermined advertisement server and periodically updated.

In addition, the advertisement display apparatus further includes a second point management unit for accumulating and adding points (cash) whenever the advertisement contents are displayed or the number of times of displaying the advertisement contents exceeds a set number and transmitting a result thereof to a point management server to inform the points when the user requests or each time a set time period is elapsed, when the advertisement contents are displayed through the call/rejection combination button bar.

Preferably, the advertisement display apparatus further includes an advertisement object indication unit for providing an advertisement by displaying an advertisement object (e.g., an image, text, flash or the like) containing advertisement contents, together with a corresponding indication icon, when arrival of predetermined indication information (e.g., a character message, Kakao talk, Facebook, or the like) is notified.

In addition, indication of a character message or the like is admitted when the user handles the advertisement object in a first set direction (e.g., from the left to the right or a touch), and the indication of a character message or the like is rejected when the user handles the advertisement object in a second set direction (e.g., from the right to the left or a touch).

### Advantageous Effect

The present invention has following effects.

First, the advertisement display apparatus of a mobile communication terminal provided with both a call allowance button bar and a call rejection button bar according to a first embodiment of the present invention inserts and displays advertisement contents on a predetermined first set screen (or area) inside the call allowance button bar if it is sensed that a user handles the call allowance button bar, and inserts and displays advertisement contents on a predetermined second set screen (or area) inside the call rejection button bar if it is sensed that the user handles the call rejection button bar, and thus an advertiser may effectively provide the advertisement to the user using the call allowance button bar or the call rejection button bar, and the user may view the advertisement through the call allowance button bar or the call rejection button bar and, in addition, obtain an advantageous effect since points (or cash) are accumulated as much as the number of times of viewing the advertisement.

Second, the advertisement display method of a mobile communication terminal (e.g., a smart phone) provided with a call/rejection combination button bar for admitting a call when a user handles the button bar in a first set direction and rejecting the call when the user handles the button bar in a second set direction according to a second embodiment of the present invention inserts and displays advertisement contents on a predetermined first set screen (or area) inside the call/rejection combination button bar if it is sensed that the user handles the call/rejection combination button bar in the first set direction, and inserts and displays advertisement contents on a predetermined second set screen (or area) inside the call/rejection combination button bar if it is sensed that the user handles the call/rejection combination button bar in the second set direction, and thus an advertiser may effectively provide the advertisement to the user using the call/rejection combination button bar, and the user may view the advertisement through the call/rejection combination button bar and, in addition, obtain an advantageous effect since points (or cash) are accumulated as much as the number of times of viewing the advertisement.

Third, the advertisement display method of a mobile communication terminal using an advertisement bar (icon) according to a third embodiment of the present invention provides an advertisement by displaying an advertisement bar (icon) containing advertisement contents or an indication bar (icon) of a character message or the like on a screen when a call signal or an indication signal is input, and then admits a call or an indication when a user handles the advertisement bar (icon) or the indication bar (icon) of a character message or the like in a first set direction (e.g., from the left to the right, or a touch), and rejects the call or the indication when the user handles the advertisement bar (icon) or the indication bar (icon) of a character message or the like in a second set direction (e.g., from the right to the left, or a touch), and thus an advertiser may effectively provide the advertisement to the user using the advertisement bar (icon) or the indication bar (icon) of a character message or the like, and the user may view the advertisement through the advertisement bar (icon) or the indication bar (icon) of a character message or the like and, in addition, obtain an advantageous effect since points (or cash) are accumulated as much as the number of times of viewing the advertisement.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a block diagram showing an advertisement display apparatus of a mobile communication terminal using button bar according to a first embodiment of the present invention;

FIG. 2 is a flowchart sequentially illustrating an operation of an advertisement display apparatus of a mobile communication terminal using a button bar according to a first embodiment of the present invention;

FIG. 3 is a block diagram showing an advertisement display apparatus of a mobile communication terminal using a button bar according to a second embodiment of the present invention;

FIG. 4 is a flowchart sequentially illustrating an operation of an advertisement display apparatus of a mobile communication terminal using a button bar according to a second embodiment of the present invention;

FIG. 5a is a view showing an advertisement display method using a call allowance button bar according to a first embodiment of the present invention;

FIG. 5b is a view showing an advertisement display method using a call rejection button bar according to a first embodiment of the present invention;

FIG. 6a is a view showing an advertisement display method when a call of a mobile communication terminal provided with a call/rejection combination button bar is admitted according to a second embodiment of the present invention;

FIG. 6b is a view showing an advertisement display method when a call of a mobile communication terminal provided with a call/rejection combination button bar is rejected according to a second embodiment of the present invention;

FIG. 7a is a view showing an advertisement display method according to a third embodiment of the present invention; and

FIG. 7b is a view showing an advertisement display method using an indication bar (or icon) according to the present invention.

### EXPLANATION OF REFERENCE NUMERALS

101: Call allowance button bar
102: Call rejection button bar
103: First sensing module
104: First advertisement insertion module
105: Second advertisement insertion module
106: First point management unit
301: Call/rejection combination button bar
302: Second sensing module
303: Third advertisement insertion module
304: Fourth advertisement insertion module
305: Second point management unit

### PREFERRED EMBODIMENTS OF THE INVENTION

Hereinafter, the present invention will be described with reference to the accompanying drawings.

The matters defined in the description, such as the detailed construction and elements, are nothing but specific details provided to assist those of ordinary skill in the art in a comprehensive understanding of the invention, and the present invention is not limited to the embodiments disclosed hereinafter.

Elements unrelated to the description are omitted in order to clearly describe the present invention, and like numbers refer to like elements throughout the specification.

When an element includes a constitutional component throughout the specification and claims, this means further including another constitutional element, not excluding another constitutional element, as far as an opposed description is not specially specified.

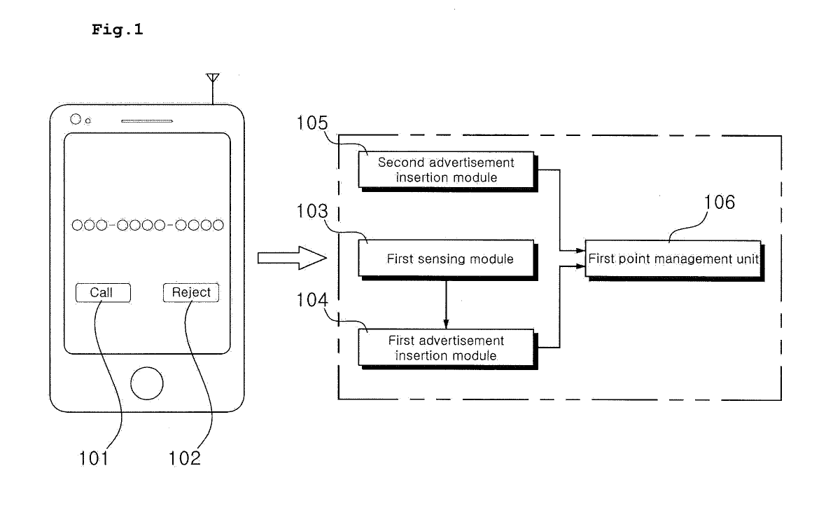

FIG. 1 is a block diagram showing an advertisement display apparatus of a mobile communication terminal using a button bar (or icon) or an indication bar (or icon) of a character message or the like according to a first embodiment of the present invention.

As shown in FIG. 1, the apparatus is embedded in a mobile communication terminal (e.g., a smart phone) provided with a call allowance button bar 101 and a call rejection button bar 102 and has a structure largely including a first sensing module 103 and a first advertisement insertion module 104 which can include a display module therein. Additionally, it is a structure configured to further include a second advertisement insertion module 105 and a first point management unit 106.

Here, in an advertisement display apparatus of a mobile communication terminal provided with the call allowance button bar 101 and the call rejection button bar 102, the first sensing module 103 senses whether a user handles the call allowance button bar 101 or the call rejection button bar 102. That is, the first sensing module 103 senses whether the user handles the call allowance button bar 101 or the call rejection button bar 102 in a set direction (e.g., from the left to the right) and outputs a corresponding signal to the first advertisement insertion module 104. For example, if it is sensed that the user handles the call allowance button bar 101 in the set direction (e.g., from the left to the right), a first handling signal is output to the first advertisement insertion module 104. On the other hand, if it is sensed that the user handles the call rejection button bar 102 in the set direction (e.g., from the left to the right), a second handling signal is output to the first advertisement insertion module 104.

If it is sensed that the user handles the call allowance button bar 101 as a result of the sensing by the first sensing module 103 (i.e., when the first handling signal is input from the first sensing module 103), the first advertisement insertion module 104 inserts and displays advertisement contents (e.g., an image, a script, flash, text or the like) on a predetermined first set screen (or area) inside the call allowance button bar 101 (e.g., on the left side of the call allowance button bar). In addition, if it is sensed that the user handles the call rejection button bar 102 as a result of the sensing by the first sensing module 103 (i.e., the second handling signal is input from the first sensing module 103), the first advertisement insertion module 104 inserts and displays advertisement contents on a predetermined second set screen (or area) inside the call rejection button bar 102. At this point, a plurality of the advertisement contents may be previously stored in memory or the like, and, in this case, any one of the advertisement contents may be selected using a set sequence or a random method determined by the user, an advertiser or the like among the plurality of the stored advertisement contents and inserted in the call allowance button bar 101 or the call rejection button bar 102, and the advertisement contents may be received from a predetermined advertisement server (not shown) and periodically updated.

The second advertisement insertion module 105 senses whether or not the call is terminated and, if termination of the call is sensed as a result of the sensing (e.g., when a call termination button is clicked), inserts and displays advertisement contents on a predetermined third set screen (or area) (e.g., an area at the center of the screen of the terminal).

When the advertisement contents are displayed through the call allowance button bar 101 or the call rejection button bar 102, the first point management unit 106 accumulates and adds points (or cash) of a corresponding user whenever the advertisement contents are displayed or the number of times of displaying the advertisement contents exceeds a set number and transmits a result thereof to a point management server to inform the points when the user requests or each time a set time period is elapsed.

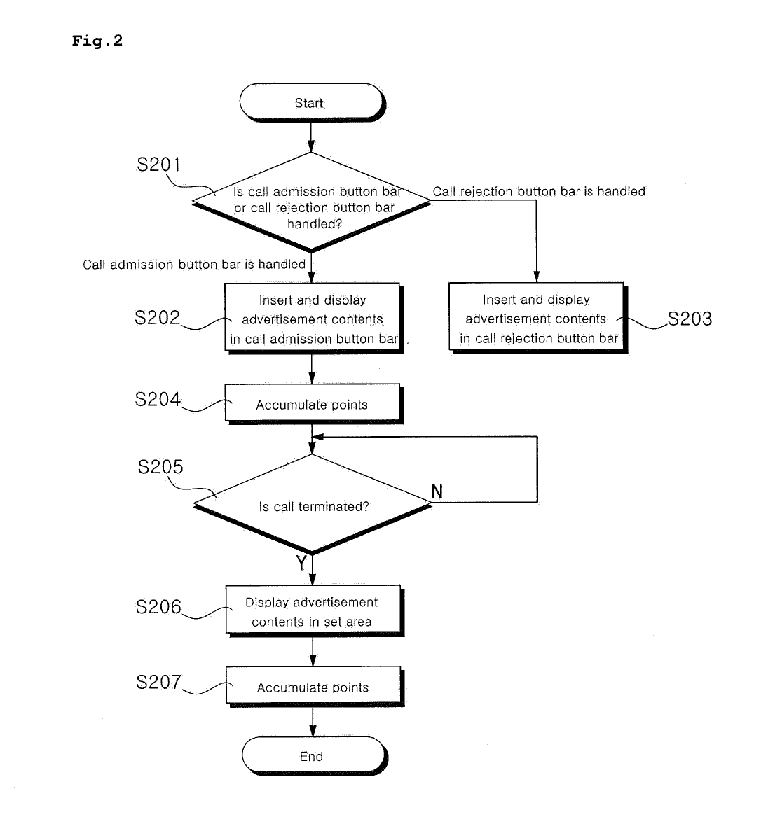

Hereinafter, the operation of an advertisement display apparatus of a mobile communication terminal using a call allowance button bar or a call rejection button bar according to a first embodiment of the present invention of FIG. 1 will be described with reference to accompanying FIG. 2.

FIG. 2 is a flowchart sequentially illustrating an operation of an advertisement display apparatus of a mobile communication terminal using a call allowance button bar or a call rejection button bar according to a first embodiment of the present invention.

As shown in FIG. 2, first, the apparatus senses whether a user handles the call allowance button bar or the call rejection button bar 5201.

That is, it is sensed whether the user handles the call allowance button bar or the call rejection button bar in a set direction (e.g., a direction from the left to the right), and a corresponding signal is output to the first advertisement insertion module.

For example, if it is sensed that the user handles the call allowance button bar in a set direction (e.g., a direction from the left to the right), a first handling signal is output to the first advertisement insertion module.

On the other hand, if it is sensed that the user handles the call rejection button bar in a set direction (e.g., a direction from the left to the right), a second handling signal is output to the first advertisement insertion module.

Next, if it is sensed that the user handles the call allowance button bar as a result of the sensing by the first sensing module (i.e., when the first handling signal is input from the first sensing module), the first advertisement insertion module inserts and displays advertisement contents (e.g., an image, a script, flash, text or the like) on a predetermined first set screen (or area) inside the call allowance button bar (e.g., on the left side of the call allowance button bar) 5202.

On the other hand, if it is sensed that the user handles the call rejection button bar as a result of the sensing by the first sensing module (i.e., the second handling signal is input from the first sensing module), the first advertisement insertion module inserts and displays advertisement contents on a predetermined second set screen (or area) inside the call rejection button bar S203.

At this point, a plurality of the advertisement contents may be previously stored in memory or the like, and in this case, any one of the advertisement contents may be selected using a set sequence or a random method determined by the user, an advertiser or the like among the plurality of the stored advertisement contents and inserted in the call allowance button bar or the call rejection button bar, and the advertisement contents may be received from a predetermined advertisement server and periodically updated.

Meanwhile, the second advertisement insertion module senses whether or not the call is terminated and, if termination of the call is sensed as a result of the sensing (e.g., when a call termination button is clicked), inserts and displays advertisement contents (e.g., an image, a script, flash, text or the like) on a predetermined third set screen (or area) (e.g., an area at the center of the screen of the terminal) S205 and S206.

Insertion of the advertisement contents may be accomplished in a method of storing a plurality of advertisement contents in advance, selecting any one of the advertisement contents using a set sequence or a random method among the plurality of the stored advertisement contents, and inserting the advertisement contents in the call allowance button bar or the call rejection button bar, and the advertisement contents may be received from a predetermined advertisement server and periodically updated.

Then, when the advertisement contents are displayed through the call allowance button bar or the call rejection button bar, the first point management unit accumulates and adds points (or cash) of a corresponding user whenever the advertisement contents are displayed or the number of times of displaying the advertisement contents exceeds a set number S204 and S207 and transmits a result thereof to a point management server to inform the points when the user requests or each time a set time period is elapsed.

As described above, the advertisement display apparatus of a mobile communication terminal provided with both the call allowance button bar and the call rejection button bar according to a first embodiment of the present invention inserts and displays advertisement contents on a predetermined first set screen (or area) inside the call allowance button bar if it is sensed that a user handles the call allowance button bar, and inserts and displays advertisement contents on a predetermined second set screen (or area) inside the call rejection button bar if it is sensed that the user handles the call rejection button bar, and thus an advertiser may effectively provide an advertisement to the user using the call allowance button bar or the call rejection button bar, and the user may view the advertisement through the call allowance button bar or the call rejection button bar and, in addition, obtain an advantageous effect since points (or cash) are accumulated as much as the number of times of viewing the advertisement.

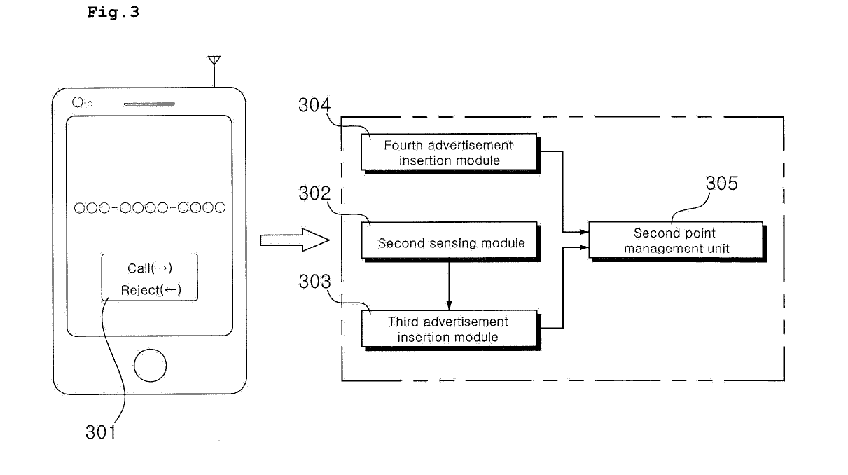

FIG. 3 is a view showing an advertisement display apparatus of a mobile communication terminal using a call/rejection combination button bar according to a second embodiment of the present invention.

As shown in FIG. 3, the apparatus is embedded in a mobile communication terminal provided with a call/rejection combination button bar 301 for admitting a call when a user handles the button bar in a first set direction and rejecting the call when the user handles the button bar in a second set direction and has a structure largely including a second sensing module 302 and a third advertisement insertion module 303 which can include a display module therein. Additionally, it is a structure configured to further include a fourth advertisement insertion module 304 and a second point management unit 305.

Here, in an advertisement display apparatus of a mobile communication terminal provided with the call/rejection combination button bar 301 for admitting a call when the user handles the button bar in a first set direction and rejecting the call when the user handles the button bar in a second set direction, the second sensing module 302 senses whether or not the user handles the call/rejection combination button bar 301. That is, if the user admits the call by handling the call/rejection combination button bar 301 in the first set direction (e.g., from the left to the right), a first handling signal is output to the third advertisement insertion module 303, and if the user rejects the call by handling the call/rejection combination button bar 301 in the second set direction (e.g., from the right to the left), a second handling signal is output to the third advertisement insertion module 303.

If it is sensed that the user handles the call/rejection combination button bar 301 in the first set direction as a result of the sensing by the second sensing module 302 (i.e., when the first handling signal is input from the second sensing module 302), the third advertisement insertion module 303 inserts and displays advertisement contents (e.g., an image, a script, flash, text or the like) on a predetermined first set screen (or area) inside the call/rejection combination button bar 301. On the other hand, if it is sensed that the user handles the call/rejection combination button bar 301 in the second set direction as a result of the sensing by the second sensing module 302 (i.e., when the second handling signal is input from the second sensing module 302), the third advertisement insertion module 303 inserts and displays advertisement contents in a predetermined second set screen (or area) inside the call/rejection combination button bar 301. Insertion of the advertisement contents may be accomplished in a method of storing a plurality of advertisement contents in advance, selecting any one of the advertisement contents using a set sequence or a random method among the plurality of the stored advertisement contents, and inserting the advertisement contents in the call/rejection combination button bar, and the advertisement contents may be received from a predetermined advertisement server and periodically updated.

The fourth advertisement insertion module 304 senses whether or not the call is terminated and, if termination of the call is sensed as a result of the sensing (e.g., when a call termination button is clicked), inserts and displays advertisement contents on a predetermined third set screen (or area). At this point, insertion of the advertisement contents may be accomplished in a method of storing a plurality of advertisement contents in advance, selecting any one of the advertisement contents using a set sequence or a random method among the plurality of the stored advertisement contents, and inserting the advertisement contents in the call/rejection combination button bar, and the advertisement contents may be received from a predetermined advertisement server and periodically updated.

When the advertisement contents are displayed through the call/rejection combination button bar 301, the second point management unit 305 accumulates and adds points (or cash) of a corresponding user whenever the advertisement contents are displayed or the number of times of displaying the advertisement contents exceeds a set number and transmits a result thereof to a point management server to inform the points when the user requests or each time a set time period is elapsed.

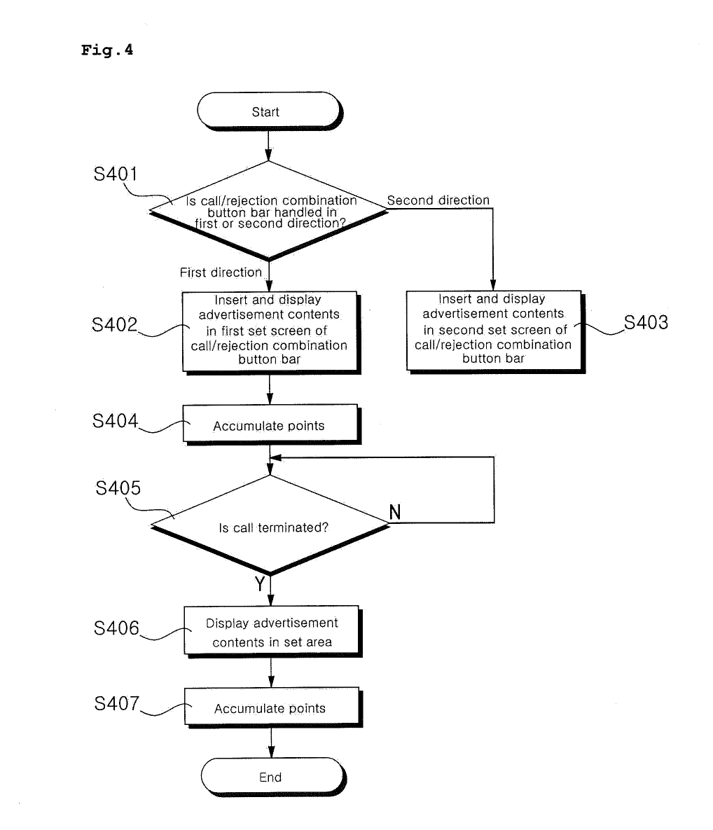

Hereinafter, the operation of an advertisement display apparatus of a mobile communication terminal using a call/rejection combination button bar according to a second embodiment of the present invention of FIG. 3 will be described with reference to accompanying FIG. 4.

FIG. 4 is a flowchart sequentially illustrating an operation of an advertisement display apparatus of a mobile communication terminal using a call/rejection combination button bar according to a second embodiment of the present invention,

As shown in FIG. 4, first, the apparatus senses whether or not a user handles the call/rejection combination button bar for admitting a call when the user handles the button bar in a first set direction and rejecting the call when the user handles the button bar in a second set direction S401.

That is, if the user admits the call by handling the call/rejection combination button bar in the first set direction (e.g., from the left to the right), a first handling signal is output to the third advertisement insertion module.

On the other hand, if the user rejects the call by handling the call/rejection combination button bar in the second set direction (e.g., from the right to the left), a second handling signal is output to the third advertisement insertion module.

Next, if it is sensed that the user handles the call/rejection combination button bar in the first set direction as a result of the sensing by the second sensing module (i.e., when the first handling signal is input from the second sensing module), the third advertisement insertion module inserts and displays advertisement contents (e.g., an image, a script, flash, text or the like) on a predetermined first set screen (or area) inside the call/rejection combination button bar S402.

On the other hand, if it is sensed that the user handles the call/rejection combination button bar in the second set direction as a result of the sensing by the second sensing module (i.e., when the second handling signal is input from the second sensing module), the third advertisement insertion module inserts and displays advertisement contents on a predetermined second set screen (or area) inside the call/rejection combination button bar S403.

Insertion of the advertisement contents may be accomplished in a method of storing a plurality of advertisement contents in advance, selecting any one of the advertisement contents using a set sequence or a random method among the plurality of the stored advertisement contents, and inserting the advertisement contents in the call/rejection combination button bar, and the advertisement contents may be received from a predetermined advertisement server and periodically updated.

Meanwhile, the fourth advertisement insertion module senses whether or not the call is terminated and, if termination of the call is sensed as a result of the sensing (e.g., when a call termination button is clicked), inserts and displays advertisement contents on a predetermined third set screen (or area) S405 and S406. Insertion of the advertisement contents may be accomplished in a method of storing a plurality of advertisement contents in advance, selecting any one of the advertisement contents using a set sequence or a random method among the plurality of the stored advertisement contents, and inserting the advertisement contents in the call/rejection combination button bar, and the advertisement contents may be received from a predetermined advertisement server and periodically updated.

Then, when the advertisement contents are displayed through the call/rejection combination button bar, the second point management unit accumulates and adds points (or cash) of a corresponding user whenever the advertisement contents are displayed or the number of times of displaying the advertisement contents exceeds a set number and transmits a result thereof to a point management server to inform the points when the user requests or each time a set time period is elapsed.

As described above, the advertisement display method according to a second embodiment of the present invention inserts and displays advertisement contents on a predetermined first set screen (or area) inside the call/rejection combination button bar if it is sensed that a user handles the call/rejection combination button bar in the first set direction, and inserts and displays advertisement contents on a predetermined second set screen (or area) inside the call/rejection combination button bar if it is sensed that the user handles the call/rejection combination button bar in the second set direction, and thus an advertiser may effectively provide an advertisement to the user using the call/rejection combination button bar, and the user may view the advertisement through the call/rejection combination button bar and, in addition, obtain an advantageous effect since points (or cash) are accumulated as much as the number of times of viewing the advertisement.

Hereinafter, an advertisement display apparatus according to a third embodiment of the present invention is described as follows.

The advertisement display apparatus according to a third embodiment of the present invention is embedded in a mobile communication terminal such as a smart phone and has a structure largely including an advertisement bar insertion module and a call processing module.

That is, it is a structure including the advertisement bar insertion module for providing an advertisement by displaying an advertisement bar containing advertisement contents on a screen when a call signal is input, and the call processing module for admitting a call when a user handles the advertisement bar in a first set direction (e.g., from the left to the right) and rejecting the call when the user handles the advertisement bar in a second set direction (e.g., from the right to the left).

At this point, insertion of the advertisement contents (e.g., an image, flash, a script, text or the like) is accomplished such that a plurality of the advertisement contents may be stored in advance, and in this case, any one of the advertisement contents may be selected using a set sequence or a random method among the plurality of the stored advertisement contents and inserted in the advertisement bar, and the advertisement contents may be received from a predetermined advertisement server (not shown) and periodically updated.

Then, when the advertisement contents are displayed through the advertisement bar, the advertisement display apparatus may further include a point management module for accumulating and adding points (or cash) whenever the advertisement contents are displayed or the number of times of displaying the advertisement contents exceeds a set number and transmitting a result thereof to a point management server to inform the points when the user requests or each time a set time period is elapsed.

In addition, the advertisement display apparatus may further include an advertisement object indication unit for providing an advertisement by displaying an advertisement object (e.g., an image, text, flash or the like) containing advertisement contents, together with a corresponding indication icon, when arrival of predetermined indication information (e.g., a character message, Kakao talk, Facebook, or the like) is notified.

At this point, the advertisement object indication unit admits indication such as a character message or the like when the user handles the advertisement object in a first set direction (e.g., from the left to the right) and rejects the indication such as a character message or the like when the user handles the advertisement object in a second set direction (e.g., from the right to the left).

In addition, a plurality of the advertisement contents may be stored in advance, and in this case, any one of the advertisement contents may be selected using a set sequence or a random method among the plurality of the stored advertisement contents and inserted in the advertisement bar, and the advertisement contents may be received from a predetermined advertisement server (not shown) and periodically updated.

Additionally, when the advertisement contents are displayed through the advertisement object, the advertisement display apparatus may further include a point management module for accumulating and adding points (or cash) whenever the advertisement contents are displayed or the number of times of displaying the advertisement contents exceeds a set number and transmitting a result thereof to a point management server to inform the points when the user requests or each time a set time period is elapsed.

In addition, the advertisement display apparatus may further include an advertisement insertion module for sensing whether or not the call is terminated and, if termination of the call is sensed as a result of the sensing, inserting and displaying advertisement contents on a predetermined set screen (or area).

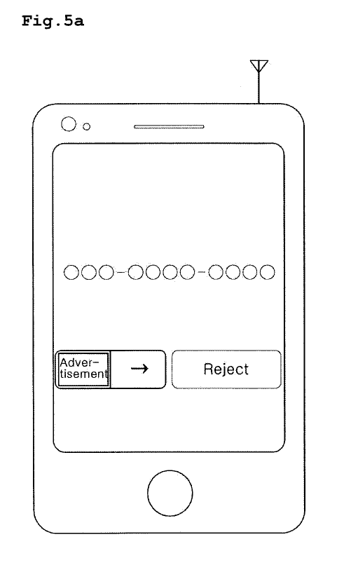

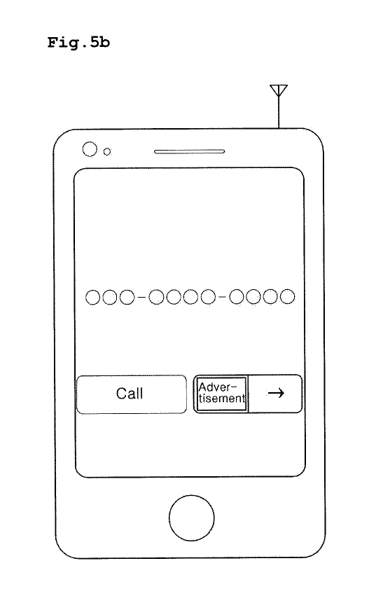

FIG. 5a and FIG. 5b are views showing an advertisement display method of a mobile communication terminal (e.g., a smart phone) provided with both a call allowance button bar and a call rejection button bar according to a first embodiment of the present invention, in which FIG. 5a is a view showing an advertisement display method using the call allowance button bar, and FIG. 5b is a view showing an advertisement display method using the call rejection button bar.

As shown in FIG. 5a, if it is sensed that a user handles the call allowance button bar, the advertisement display method according to a first embodiment of the present invention inserts and displays advertisement contents (e.g., an image, a script, flash, text or the like) in a predetermined first set screen (or area) inside the call allowance button bar (e.g., on the left side of the call allowance button bar). In addition, as shown in FIG. 5b, if it is sensed that the user handles the call rejection button bar, the advertisement display method inserts and displays advertisement contents on a predetermined second set screen (or area) inside the call rejection button bar.

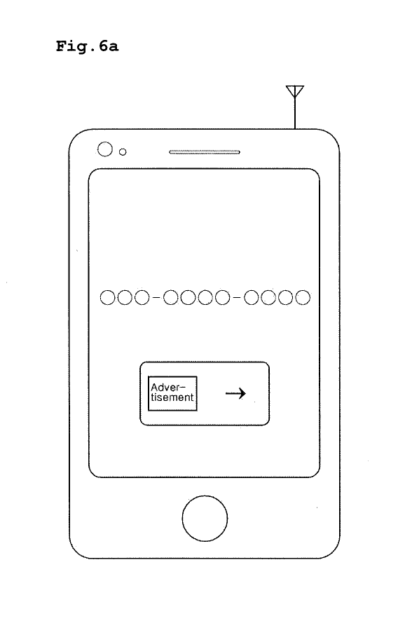

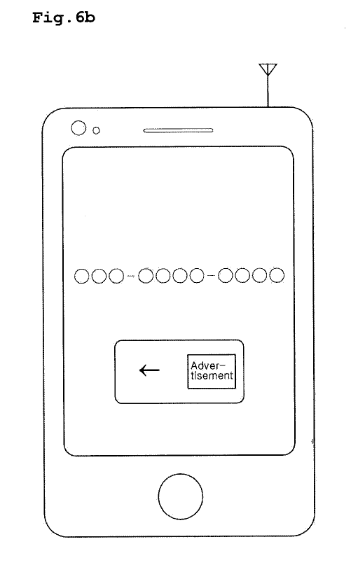

FIG. 6a and FIG. 6b are views showing an advertisement display method of a mobile communication terminal (e.g., a smart phone) provided with a call/rejection combination button bar according to a second embodiment of the present invention, in which FIG. 6a is a view showing an advertisement display method when a call is admitted, and FIG. 6b is a view showing an advertisement display method when a call is rejected.

As shown in FIG. 6a, when a user handles the call/rejection combination button bar in a first set direction (e.g., from the left to the right), the advertisement display method according to a second embodiment of the present invention inserts and displays advertisement contents (e.g., an image, a script, flash, text or the like) on a predetermined first set screen (or area) inside the call/rejection combination button bar. On the other hand, when the user handles the call/rejection combination button bar in a second set direction (e.g., from the right to the left), the advertisement display method inserts and displays advertisement contents on a predetermined second set screen (or area) inside the call/rejection combination button bar.

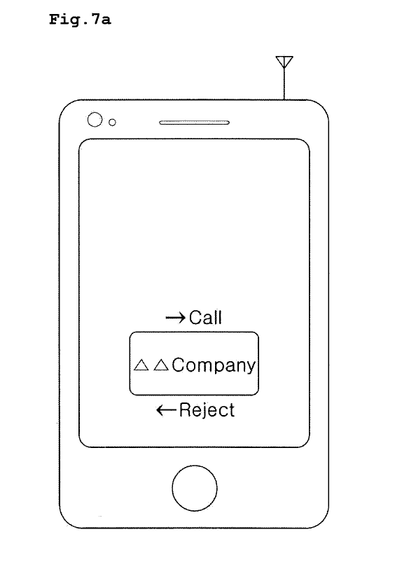

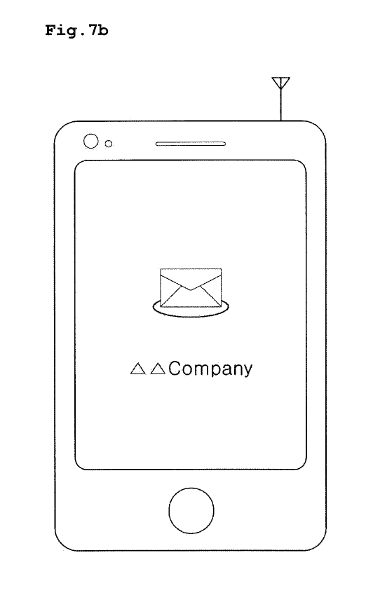

FIG. 7a is a view showing an advertisement display method according to a third embodiment of the present invention, and FIG. 7b is a view showing an advertisement display method using an indication bar according to the present invention.

As shown in FIG. 7a, the present invention provides an advertisement by displaying an advertisement bar (icon) containing advertisement contents on a screen when a call signal is input, admits a call when a user handles the advertisement bar (icon) in a first set direction (e.g., from the left to the right, or a touch or the like), and rejects the call when the user handles the advertisement bar (icon) in a second set direction (e.g., from the right to the left, or a touch or the like).

As shown in FIG. 7b, the present invention provides an advertisement by displaying an advertisement object (e.g., an image, text, flash or the like) containing advertisement contents, together with a corresponding indication icon, when arrival of predetermined indication information (e.g., a character message, Kakao talk, Facebook, or the like) is notified.

In addition, indication such as a character message or the like is admitted when the user handles the advertisement object in the first set direction (e.g., from the left to the right, or a touch) and rejected when the user handles the advertisement in the second set direction (e.g., from the right to the left, or a touch).

### INDUSTRIAL APPLICABILITY

The present invention may be applicable to a mobile communication terminals market, particularly, a smart phone market, in which an advertisement can effectively provided to a user using a call allowance/rejection button bar (or icon) or an indication bar (an icon) of a character message or the like.

While the present invention has been described in connection with the specific embodiments illustrated in the drawings, they are merely illustrative, and the invention is not limited to these embodiments. It is to be understood that various equivalent modifications and variations of the embodiments can be made by a person having an ordinary skill in the art without departing from the spirit and scope of the present invention. Therefore, the true technical scope of the present invention should not be defined by the above-mentioned embodiments but should be defined by the appended claims and equivalents thereof.

1. In an advertisement display method of a mobile communication terminal provided with a call allowance button bar and a call rejection button bar and including a control unit for controlling to admit a call when a user handles the call allowance button bar and to reject the call when the user handles the call rejection button bar, the advertisement display method of a mobile communication terminal using a button bar or an indication bar, the method comprising the steps of:
sensing whether or not the user handles the call allowance button bar or the call rejection button bar, by the control unit;
controlling to insert and display advertisement contents on a first set area inside the call allowance button bar and admit the call if it is sensed that the user handles the call allowance button bar as a result of the sensing, by the control unit; and
controlling to insert and display advertisement contents on a second set area inside the call rejection button bar and reject the call if it is sensed that the user handles the call rejection button bar as a result of the sensing, by the control unit.

2. The method of claim 1, further comprising the step of sensing whether or not the call is terminated and, if termination of the call is sensed as a result of the sensing, inserting advertisement contents in a third set area and displaying the advertisement contents for a set time period, by the control unit.

3. (canceled)

4. (canceled)

5. (canceled)

6. In an advertisement display method of a mobile communication terminal provided with a call/rejection combination button bar for admitting a call when a user handles the button bar in a first set direction and rejecting the call when the user handles the button bar in a second set direction and including a control unit for controlling to admit the call when the user handles the call/rejection combination button bar in the first set direction and to reject the call when the user handles the call/rejection combination button bar in the second set direction, the advertisement display method of a mobile communication terminal using a button bar or an indication bar, the method comprising the steps of:
sensing whether or not the user handles the call/rejection combination button bar, by the control unit;
controlling to insert and display advertisement contents on a first set area inside the call/rejection combination button bar and admit the call if it is sensed that the user handles the call/rejection combination button bar in the first set direction as a result of the sensing, by the control unit; and
controlling to insert and display advertisement contents on a second set area inside the call/rejection combination button bar and reject the call if it is sensed that the user handles the call/rejection combination button bar in the second set direction as a result of the sensing, by the control unit.

7. The method of claim 6, further comprising the step of sensing whether or not the call is terminated and, if termination of the call is sensed as a result of the sensing, inserting advertisement contents in a third set area and displaying the advertisement contents for a set time period, by the control unit.

8. (canceled)

9. (canceled)

10. (canceled)

11. In an advertisement display method of a mobile communication terminal provided with a control unit for admitting a call or rejecting the call according to a request of a user when a call signal is input, the advertisement display method of a mobile communication terminal using a button bar or an indication bar, the method comprising the steps of:
providing an advertisement to the user by controlling to display an advertisement bar containing advertisement contents on a screen when the call signal is input, by the control unit;
sensing whether or not the user handles the advertisement bar, by the control unit; and
controlling to admit a call if it is sensed that the user handles the advertisement bar in a first set direction and controlling to reject the call if it is sensed that the user handles the advertisement bar in a second set direction, as a result of the sensing, by the control unit.

12. (canceled)

13. (canceled)

14. The method of claim 11, further comprising the step of accumulating and adding points whenever the advertisement contents are displayed or the number of times of displaying the advertisement contents exceeds a set number and transmitting a result thereof to a point management server to inform the points when the user requests or each time a set time period is elapsed, by the control unit, when the advertisement contents are displayed through the advertisement bar.

15. The method of claim 11, further comprising the step of providing an advertisement to the user by controlling to display an advertisement object containing advertisement contents, together with a corresponding indication icon, when arrival of indication information is notified, by the control unit.

16. The method of claim 15, wherein indication is admitted when the user handles the advertisement object in a first set direction, and the indication is rejected when the user handles the advertisement object in a second set direction.

17. The method of claim 11, further comprising the step of sensing whether or not the call is terminated and, if termination of the call is sensed as a result of the sensing, inserting advertisement contents in a third set area and displaying the advertisement contents for a set time period, by the control unit.

18. In an advertisement display method of a mobile communication terminal provided with a control unit for controlling to display a corresponding indication icon on a screen when arrival of indication information is notified, the advertisement display method of a mobile communication terminal using a button bar or an indication bar, the method comprising the steps of:
providing an advertisement to a user by controlling to display an advertisement object containing advertisement contents, together with the corresponding indication icon, when arrival of indication information is notified, by the control unit;
sensing whether or not the user handles the advertisement object, by the control unit; and
admitting indication if it is sensed that the user handles the advertisement object in a first set direction and rejecting the indication if it is sensed that the user handles the advertisement object in a second set direction, as a result of the sensing, by the control unit.

19. In an advertisement display apparatus of a mobile communication terminal provided with a call allowance button bar and a call rejection button bar, the advertisement display apparatus of a mobile communication terminal using a button bar or an indication bar, the apparatus comprising:
a first sensing module for sensing whether a user handles the call allowance button bar or the call rejection button bar; and
a first advertisement insertion module for inserting and displaying advertisement contents on a first set area inside the call allowance button bar if it is sensed that the user handles the call allowance button bar as a result of the sensing, and inserting and displaying advertisement contents on a second set area inside the call rejection button bar if it is sensed that the user handles the call rejection button bar as a result of the sensing.

20. The apparatus of claim 19, further comprising a second advertisement insertion module for sensing whether or not the call is terminated and, if termination of the call is sensed as a result of the sensing, inserting and displaying advertisement contents on a third set area.

21. (canceled)

22. (canceled)

23. The apparatus of claim 19, further comprising a first point management unit for accumulating and adding points whenever the advertisement contents are displayed or the number of times of displaying the advertisement contents exceeds a set number and transmitting a result thereof to a point management server to inform the points when the user requests or each time a set time period is elapsed, when the advertisement contents are displayed through the call allowance button bar or the call rejection button bar.

24. In an advertisement display apparatus of a mobile communication terminal provided with a call/rejection combination button bar for admitting a call when a user handles the button bar in a first set direction and rejecting the call when the user handles the button bar in a second set direction, the advertisement display apparatus of a mobile communication terminal using a button bar or an indication bar, the apparatus comprising:
a second sensing module for sensing whether or not the user handles the call/rejection combination button bar; and
a third advertisement insertion module for inserting and displaying advertisement contents on a predetermined first set area inside the call/rejection combination button bar if it is sensed that the user handles the call/rejection combination button bar in the first set direction as a result of the sensing, and inserting and displaying advertisement contents on a predetermined second set area inside the call/rejection combination button bar if it is sensed that the user handles the call/rejection combination button bar in the second set direction as a result of the sensing.

25. The apparatus of claim 24, further comprising a fourth advertisement insertion module for sensing whether or not the call is terminated and, if termination of the call is sensed as a result of the sensing, inserting and displaying advertisement contents on a predetermined third set area.

26. (canceled)

27. (canceled)

28. (canceled)

29. An advertisement display apparatus of a mobile communication terminal using a button bar or an indication bar, the apparatus comprising:
an advertisement bar insertion module for providing an advertisement by displaying an advertisement bar containing advertisement contents on a screen when a call signal is input; and
a call processing module for admitting a call when a user handles the advertisement bar in a first set direction and rejecting the call when the user handles the advertisement bar in a second set direction.

30. (canceled)

31. The apparatus of claim 29, further comprising a point management unit for accumulating and adding points whenever the advertisement contents are displayed or the number of times of displaying the advertisement contents exceeds a set number and transmitting a result thereof to a point management server to inform the points when the user requests or each time a set time period is elapsed, when the advertisement contents are displayed through the advertisement bar.

32. The apparatus of claim 29, further comprising an advertisement object indication unit for providing an advertisement by displaying an advertisement object containing advertisement contents, together with a corresponding indication icon, when arrival of predetermined indication information is notified.

33. The apparatus of claim 32, wherein the advertisement object indication unit admits indication when the user handles the advertisement object in a first set direction and rejects the indication when the user handles the advertisement object in a second set direction.

34. The apparatus of claim 29, further comprising an advertisement insertion module for sensing whether or not the call is terminated and, if termination of the call is sensed as a result of the sensing, inserting and displaying advertisement contents on a predetermined set area.
